(19) United States
(12) Patent Application Publication
(10) Pub. No.: US 2024/0154688 A1
(43) Pub. Date: May 9, 2024

(54) MANAGEMENT OF COMMUNICATION CONNECTION OF UNMANNED AERIAL VEHICLE

(71) Applicant: TELIA COMPANY AB, SOLNA (SE)

(72) Inventors: Tero JALKANEN, TUUSULA (FI); Tomi SARAJISTO, HELSINKI (FI)

(21) Appl. No.: 18/549,793

(22) PCT Filed: Mar. 9, 2022
(86) PCT No.: PCT/EP2022/055963

§ 371 Date: Sep. 8, 2023

(30) Foreign Application Priority Data
Mar. 10, 2021 (FI) 20215256

(51) Int. Cl. H04B 7/185; H04W 72/0453

(52) U.S. Cl. CPC H04B 7/18502; H04W 72/0453

(57) ABSTRACT

A method for managing a communication connection of an unmanned aerial vehicle is provided. The method includes: receiving data indicative of at least one requirement of a communication connection; determining at least one radio frequency band among a radio spectrum of the mobile communication network; generating a control signal at least to the unmanned aerial vehicle, the control signal including data indicating the determined at least one radio frequency band for applying the determined at least one radio frequency band in the communication between the mobile communication network and the unmanned aerial vehicle. Also an apparatus, a system, and a computer program product are provided.

### TECHNICAL FIELD

The invention concerns in general the technical field of telecommunications. More particularly, the invention concerns connection management of an unmanned aerial vehicle.

### BACKGROUND

So-called unmanned aerial vehicles (UAV) have become popular in many application areas. The UAVs are used in both business and leisure for different kinds of purposes. The development of applications the UAVs are used for requires different kinds of control measures extending even to a communication the UAVs are controlled with and/or the application in question requires.

On the other hand, an increase of UAVs used in public places has brought another aspect in consideration. Namely, due to the increase of UAVs there has risen a need to regulate the use of UAVs in order to reduce a risk of accidents, such as an UAV rushes in an uncontrolled manner to an area where people reside. This also causes pressure to the control of UAVs at every situation which is at least in part reflected by the communication to and from the UAVs.

As is known, the UAVs are equipped with a radio interface for communicating with a terminal device of a UAV operator. Such an environment is schematically illustrated in FIG. 1. The UAV 110 may be configured to communicate with the terminal device 120 of the UAV operator wherein the communication between the mentioned entities is arranged in a wireless manner e.g. over a mobile communication network 130. The communication may be understood to carry both control signals between the communicating entities, but possibly also so-called payload data relating to a task the UAV is configured to execute. For example, the payload data may refer to image or video data captured with a camera carried by the UAV 110 which is delivered e.g. to the terminal device 120 of the UAV operator. Naturally, the delivery of the payload data may also be directed to another destination, such as directly to a server device accessible through the mobile communication network 130, for example.

Hence, in order to control an operation of the UAV 110 so that the above described challenges and requirements may be followed by there is a need to in-troduce sophisticated solutions for controlling a communication of the UAV.

### SUMMARY

The following presents a simplified summary in order to provide basic under-standing of some aspects of various invention embodiments. The summary is not an extensive overview of the invention. It is neither intended to identify key or critical elements of the invention nor to delineate the scope of the invention.

The following summary merely presents some concepts of the invention in a simplified form as a prelude to a more detailed description of exemplifying embodiments of the invention.

An object of the invention is to present a method, an apparatus, a system, and a computer program product for managing a communication connection.

The objects of the invention are reached by a method, an apparatus, a system, and a computer program product as defined by the respective independent claims.

According to a first aspect, a method for managing a communication connection of an unmanned aerial vehicle, UAV, is provided, wherein the communication connection is provided by a mobile communication network, the method, performed by an apparatus, comprises: receiving data indicative of at least one requirement of a communication connection required by the unmanned aerial vehicle; determining at least one radio frequency band among a radio spectrum of the mobile communication network, the determined at least one radio frequency band complying with the at least one requirement of the communication connection required by the unmanned aerial vehicle; generating a control signal at least to the unmanned aerial vehicle, the control signal comprising data indicating the determined at least one radio frequency band for applying the determined at least one radio frequency band in the communication between the mobile communication network and the unmanned aerial vehicle.

For example, the data indicative of the at least one requirement of the communication connection required by the unmanned aerial vehicle may be received from a terminal device configured to control the unmanned aerial vehicle at least in part.

The at least one requirement of the communication connection may be defined based on a task definition of the unmanned aerial vehicle, the task definition carried in the received data. For instance, the task definition may comprise data defining at least portion of a flight route of the unmanned aerial vehicle. Still further, the task definition may comprise data indicative of an altitude of a flight of the unmanned aerial vehicle.

The method may further comprise: receiving data indicative of environmental conditions in relation to the task definition of the unmanned aerial vehicle; determining, in accordance with the data indicative of the environmental conditions, a number of radio frequency bands as candidate radio frequency bands; in the method the step of generating a control signal at least to the unmanned aerial vehicle may be performed by: comparing the candidate radio frequency bands to the at least one radio frequency band complying with the at least one requirement of the communication connection required by the unmanned aerial vehicle; setting, in accordance with a comparison between the candidate radio frequency bands to the at least one radio frequency band complying with the at least one requirement of the communication connection required by the unmanned aerial vehicle, a detection result to indicate the number of radio frequency bands existing both in the candidate radio frequency bands and the at least one radio frequency band complying with the at least one requirement of the communication connection required by the unmanned aerial vehicle; and including (450) the detection result in the data of the control signal.

The data indicative of environmental conditions in relation to the task definition of the unmanned aerial vehicle may also be received by inquiring it from data storage, the inquiry comprising data defining at least the portion of the flight route of the unmanned aerial vehicle defined in the task definition.

Moreover, the data indicative of environmental conditions over at least portion of the flight route of the unmanned aerial vehicle may be received from at least one of the following: data storage storing weather information; data storage storing local restrictions in the radio spectrum.

According to a second aspect, an apparatus for managing a communication connection of an unmanned aerial vehicle, UAV, is provided, wherein the communication connection is provided by a mobile communication network, the apparatus configured to: receive data indicative of at least one requirement of a communication connection required by the unmanned aerial vehicle; determine at least one radio frequency band among a radio spectrum of the mobile communication network, the determined at least one radio frequency band complying with the at least one requirement of the communication connection required by the unmanned aerial vehicle; generate a control signal at least to the unmanned aerial vehicle, the control signal comprising data indicating the determined at least one radio frequency band for applying the determined at least one radio frequency band in the communication between the mobile communication network and the unmanned aerial vehicle.

Moreover, the apparatus may be configured to receive the data indicative of the at least one requirement of the communication connection required by the unmanned aerial vehicle from a terminal device configured to control the unmanned aerial vehicle at least in part.

Still further, the apparatus may be configured to define the at least one requirement of the communication connection based on a task definition of the unmanned aerial vehicle, the task definition carried in the received data. For example, the apparatus may be configured to determine data defining at least portion of a flight route of the unmanned aerial vehicle from the task definition. Furthermore, the apparatus may be configured to determine data indicative of an altitude of a flight of the unmanned aerial vehicle from the task definition.

Still, the apparatus may further be configured to: receive data indicative of environmental conditions in relation to the task definition of the unmanned aerial vehicle; determine, in accordance with the data indicative of the environmental conditions, a number of radio frequency bands as candidate radio frequency bands; the apparatus may be configured to perform the step of generating a control signal at least to the unmanned aerial vehicle by: comparing the candidate radio frequency bands to the at least one radio frequency band complying with the at least one requirement of the communication connection required by the unmanned aerial vehicle; setting, in accordance with a comparison between the candidate radio frequency bands to the at least one radio frequency band complying with the at least one requirement of the communication connection required by the unmanned aerial vehicle, a detection result to indicate the number of radio frequency bands existing both in the candidate radio frequency bands and the at least one radio frequency band complying with the at least one requirement of the communication connection required by the unmanned aerial vehicle; and including the detection result in the data of the control signal. For example, the apparatus may be configured to receive the data indicative of environmental conditions in relation to the task definition of the unmanned aerial vehicle by inquiring it from data storage, the inquiry comprising data defining at least the portion of the flight route of the unmanned aerial vehicle defined in the task definition. Also, the apparatus may be configured to receive the data indicative of environmental conditions over at least portion of the flight route of the unmanned aerial vehicle from at least one of the following: data storage storing weather information; data storage storing local restrictions in the radio spectrum.

According to a third aspect, a system for managing a communication connection of an unmanned aerial vehicle, UAV, is provided, wherein the communication connection is provided by a mobile communication network, the system comprising: at least one unmanned aerial vehicle, UAV; and an apparatus according to the second aspect as defined in the foregoing description.

According to a fourth aspect, a computer program product comprising instructions is provided which computer program product, when the program is executed by a computer, cause the computer to carry out the method according to the first aspect as defined in the foregoing description.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an unmanned aerial vehicle, UAV, system according to prior art.

FIG. 2 illustrates schematically an unmanned aerial vehicle according to an example.

FIG. 3 illustrates schematically a method according to an example.

FIG. 4 illustrates schematically a method according to another example.

FIG. 5 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

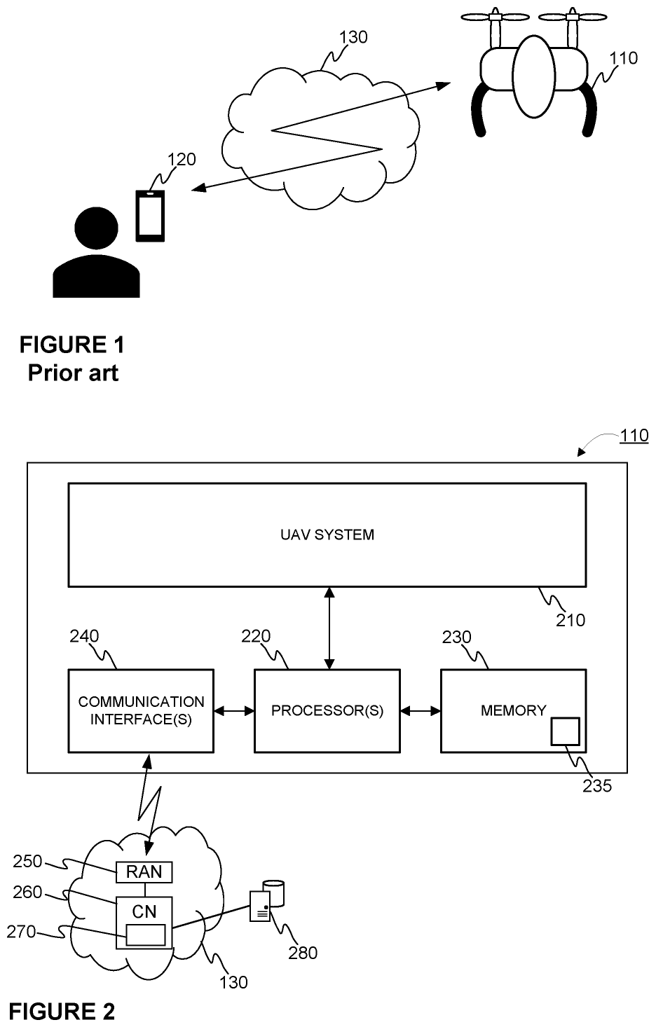

In the following description the same reference numbers with respect to the entities shown in FIG. 1 are used where applicable.

FIG. 2 illustrates schematically an example of an unmanned aerial vehicle, UAV, 110 as a block diagram in order to describe further aspects of the present invention. Each entities of the UAV 110 will be described by way of example and it shall be understood that each UAV 110 may include more or less components than those shown and described herein. For example, the UAV 110 may comprise an UAV system 210 including means, i.e. devices and systems, enabling a movement of the UAV 110. Such devices and systems may comprise motors and motor controllers which cause a power to rotors generating the lift force to the UAV 110. The UAV system 210 may also comprise sensors, batteries, and other similar entities, such as tools in relation to a task the UAV 110 is intended to perform, housed in a housing forming an exterior of the UAV 110. Furthermore, the UAV 110 may comprise one or more processors 220 configured to control an operation of the UAV 110, such as generating control signals to the motor controllers of the UAV system 210. The controlling of the operation of the UAV 110 by the at least one processor 220 may be performed by executing a computer program code 235 stored in a memory 230, which execution of the computer program code 235 by the at least one processor 220 generates instructions to different entities in the UAV 110 and, hence, the UAV 110 is oper-ative in a controlled manner. Furthermore, the UAV 110 comprises a communication interface 240 for implementing communication between the UAV 110 and another entity, such as the terminal device 120 of the UAV operator. The term i-nal device 120 may e.g. be a mobile phone, a tablet computer, a laptop computer, or any similar computing device implementing a communication technol-ogy used in the communication. In other words, the communication interface 240 may refer to one or more communication interfaces implementing one or more predefined wireless communication protocols. Such wireless communication protocols may refer to protocols complying with one or more of the following communication technologies: Global System for Mobile communication (GSM) (including General Packet Radio Service (GPRS) and Enhanced Data Rates for GSM Evolution (EDGE)), UMTS (including High Speed Packet Access (HSPA)), Long-Term Evolution (LTE), and 5G New Radio, for example. In other words, the respective communication interfaces 240 enable access to a mobile communication network 130 so as to establish the communication connection between the terminal device 120 and the UAV 110. Hence, the UAV 110 may receive data, e.g. in a form of control signals, relating to an operation of the UAV 110, which data may be interpreted by the processor 220 according to predeter-mined rules, and, finally, internal control signals may be generated e.g. to the UAV system 210. Moreover, the UAV 110 may transmit data to the terminal device 120, or to any other destination, over the communication interface 240. Such data may e.g. be generated during the task by one or more devices in the UAV 110, such as sensors or tools, like cameras or similar.

As shown in FIG. 2, the communication connection between the UAV 110 and the terminal device 120, when implemented over the mobile communication network 130, utilizes entities from both a radio access network (RAN) 250 of the mobile communication network 130 and a core network (CN) 260 of the mobile communication network 130 wherein the radio communication from the UAV 110 is performed over the radio access network 250. The core network 260, in turn, may comprise one or more apparatuses 270, such as network nodes like 5G Access and Mobility Management Function (AMF), configured to manage at least in part a communication connection of the UAV 110 as is described in the forthcoming description. Moreover, in accordance with at least some example embodiments, a control of the communication connection may utilize information available from external sources 280, such as from server devices or data storages, accessible e.g. by one or more network nodes residing in the core network. Such network nodes may e.g. be involved in controlling the communication connection between the communicating entities.

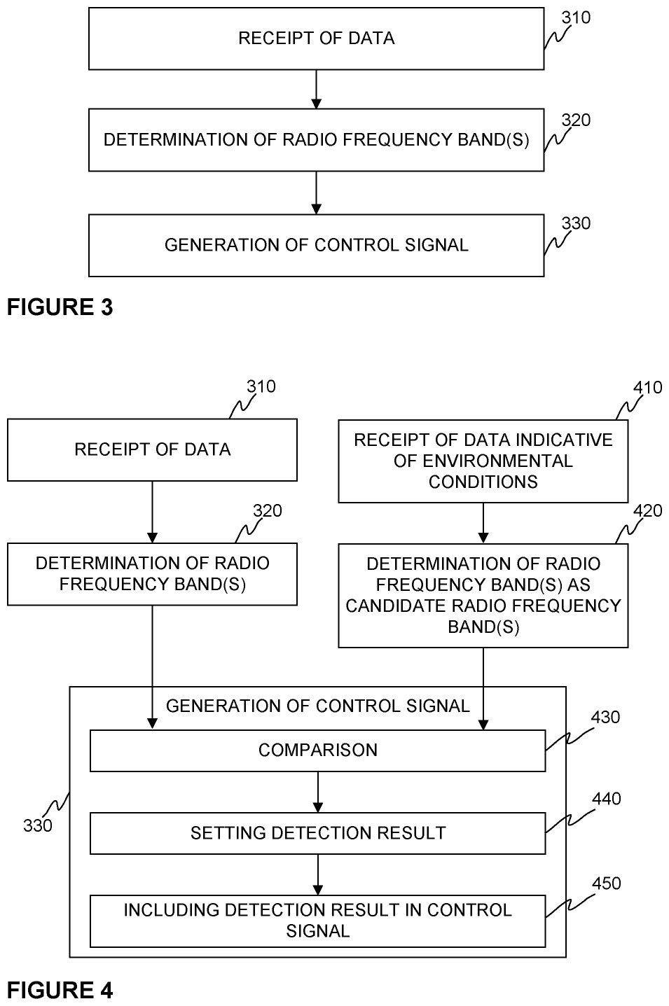

FIG. 3 illustrates a method according to an example embodiment. The method is for managing a communication connection of an unmanned aerial vehicle 110, UAV, wherein the communication connection is provided by a mobile communication network 130. The communication connection may refer to a connection between the UAV 110 and a terminal device 120 on the UAV operator. The method may be performed by an apparatus 270 configured to manage the communication connection of the UAV 110 at least in part, such as the AMF of a 5G communication network. First, the apparatus 270 may receive 310 data indicative of at least one requirement of a communication connection required by the UAV 110. The requirement of the communication connection may relate to a task assigned to the UAV 110, such as the flight is intended for capturing video images with high quality during the flight of the UAV e.g. in certain sections of a flight route. These kinds of task definitions may be defined with one or more predefined parameters in a flight plan defined for the UAV 110. In other words, such parameters may define the task assigned to the UAV 110, but also the flight plan like the flight route as geographical coordinates also including e.g. an indication of an altitude of the flight expressed in applicable manner, such as an average and/or with max/min values. The flight plan may e.g. be defined with the terminal device 120 of the UAV operator, or with any other computing device. Such a task definition including at least flight plan may e.g. be uploaded to a server from which it may be provided to the apparatus 270 with a predefined operation. Naturally, in case the terminal device 120 stores the task definition it may provide it to the apparatus 270. As a conclusion of some aspects as described above the at least one requirement may be received by the apparatus 270 from a terminal device 120 operated by the UAV operator.

In response to the receipt 310 of the data as described the apparatus 270 may be configured to determine 320 at least one radio frequency band among a radio spectrum of the mobile communication network 130 available for use to the UEV 110. The determination 320 of the at least one radio frequency band is performed so that it complies with the at least one requirement of the communication connection required by the UAV 110. Hence, the radio frequency band may be determined, or selected, on a basis of the task definition of the UAV 110. For example, the UAV 110 may be assigned a task of capturing video stream with high quality and deliver it in real-time to a destination, such as to the terminal device 120, or to a server configured to stream the video to viewers. The radio frequency band herein refers to a contiguous section of the radio spectrum frequencies available from the mobile communication network for communication. In other words, the radio frequency band may be defined as a single frequency or as a frequency range of contiguous frequencies. Hence, the communication connection, or a communication channel, is established over the determined radio frequency band in a manner as is described herein.

Finally, in response to the determination of the at least one radio frequency band 320 the apparatus is configured to generate 330 a control signal to the unmanned aerial vehicle 110 wherein the control signal comprises data indicating the determined at least one radio frequency band. The determined at least one radio frequency band is to be applied in the communication between the mobile communication network 130 and the unmanned aerial vehicle 110.

FIG. 4 illustrates schematically another example embodiment for managing a communication connection of an unmanned aerial vehicle 110. In the other example embodiment the apparatus 270 receives 310 the data indicative of at least one requirement of a communication connection required by the unmanned aerial vehicle 110 and determines 320 at least one radio frequency band in the same manner as described in the foregoing description relating to FIG. 3. In addition to that the apparatus is configured to receive 410 data indicative of environmental conditions in relation to a task defined for the UAV 110, such as the data indicative of environmental conditions is related to at least portion of a flight route of the unmanned aerial vehicle 110. The data indicative of the environmental conditions may e.g. refer to data indicative of weather or data indicative of local restrictions in the radio spectrum. Advantageously, both pieces of information, either separately or together, define aspects in relation to the task, such as in relation to at least portion of a flight route of the unmanned aerial vehicle 110 it flies during the task. The apparatus 270 may be configured to receive 410 such data from respective external sources 280 having access to such pieces of information, such as being data storages storing data indicative of such aspects. The data indicative of the environmental conditions may be received 410 either automatically from the respective external source 280 e.g. triggered by the terminal device 120, or any other entity. Alternatively or in addition, the apparatus 270 may be configured to receive 410 such data by inquiring it from the external source 280, such as from a respective data storage. The apparatus 270 may, for example, be arranged to generate the inquiry in response to the receipt 310 of the data indicative of at least one requirement of the communication connection required by the unmanned aerial vehicle 110 and include a piece of data received 310 to the inquiry. Such a piece of data may e.g. be a flight route definition the UAV 110 intends to perform, or at least a portion of it. By doing so the inquiry defines at least a geographical area, or space, of the flight so as allowing the external source 280 to return a location-dependent data being indicative of the environmental conditions, such as weather aspects in the geographical area, or space, and/or local restrictions in the geographical area, or space, e.g. relating to allowed/restricted radio frequencies, or radio frequency bands. Naturally, an extent of the location-dependent data may be wider than only at least the portion of the flight route, or it is at least such that it is descriptive with a predefined accuracy of the environmental conditions. Moreover, in some example embodiments the data indicative of environmental conditions may also be dependent on time i.e. the information provided for generating the data indicative of the environmental conditions comprise one or more time parameters e.g. descriptive when the task, or the flight, of the UAV 110 is intended to be executed. For sake of completeness, it is worthwhile to mention that the piece of data included in the inquiry, or provided to the external source 280 by any other manner, may also comprise further data than described above, such as data identifying a subscription used by the UAV 110 for accessing the mobile communication network 130. These pieces of data may be applied to some scenarios for determining the radio frequency bands as is described in the forthcoming description.

The data indicative of environmental conditions may cause the apparatus 270 to determine 420 a number of radio frequency bands which may be appropriate being applied in accordance with the environmental conditions. For example, if the environmental data represents weather conditions the determination 420 may comprise a derivation of quality aspects e.g. effecting to a propagation of radio signals from the environmental data over the radio spectrum provided by the mobile communication network 130 applied in the communication and based on the derived information the number of suitable radio frequency bands may be set as candidate radio frequency bands. For example, weather condition causing a deterioration to the quality on at least some radio frequency bands may be changes in background radiation in the space above the ground the UAV 110 is planned to be instructed to fly. Similarly, if the environmental conditions represent local restrictions, such as a certain frequency band is not allowed to be used, the determination of the suitable radio frequency bands may be performed accordingly and set as candidate radio frequency bands. A non-limiting example of the local restriction may be a restriction to apply certain frequency bands, such as high frequencies, if the UAV 110 intends to flight above a certain altitude. As already mentioned, the candidate radio frequency bands may also be set by applying a plurality of criteria to the radio spectrum received in the data indicative of the environmental conditions and determine those radio frequency bands as the candidate radio frequency bands which fulfill the plurality of criteria.

In the described example embodiment as schematically illustrated in FIG. 4 a function of generating 330 the control signal may receive, as an input, both the determined radio frequency band(s) from step 320 and the determined candidate radio frequency bands from step 420. In such a scenario the generation 330 of the control signal may be performed at least with the sub-steps as described in the following. First, the candidate radio frequency bands and the at least one radio frequency band complying with the at least one requirement of the communication connection required by the unmanned aerial vehicle 110 may be compared 430 together so as to set 440 a detection result of the comparison 430. The detection result may be set 440, in accordance with the comparison 430 between the candidate radio frequency bands to the at least one radio frequency band complying with the at least one requirement of the communication connection required by the unmanned aerial vehicle 110 so that the detection result indicates one or more radio frequency bands existing both among the candidate radio frequency bands and among the at least one radio frequency band complying with the at least one requirement of the communication connection required by the unmanned aerial vehicle 110. In other words, an aim is to find those radio frequency bands which exists in both lists of frequencies obtained from the two distinct determinations 320, 420. In response to the setting 440 of the detection result the data representing the detection result may be included 450 in the control signal and the control signal may be generated 330, and delivered to respective entities, such as to the UAV 110, but also to control entities, or similar, in the mobile communication network 130.

In case the method as described with different examples generates a plurality of suitable radio frequency bands to be applied in the communication connection the apparatus 270 may be configured to select one, such as a first one, and deliver information on it in the control signal to respective entities. In some more sophisticated examples the apparatus may perform weighing between the radio frequency bands in accordance with predefined rules, and select the one found out to be most prominent through the weighing process for the communication connection. For example, the ruling may be dependent on the task assigned to the UAV 110.

The scenarios described above alleviate a plurality of challenges originating from the application area of unmanned aerial vehicles 110 which due to their flying capability generate challenges for wireless communication. For example, when the UAV 110 flies above the ground it may be served by a plurality of base stations, or at least a greater number of base stations aims to provide services to the UAV 110 due to its “visibility” to them from air than for terminal devices residing in the ground, and, hence, the management of applied radio frequency bands may turn out to be important e.g. in order to prevent at least in part ping ponging between the different base stations which causes disturbances in the mobile communication network. Further, the solution according to the invention provides a solution of providing network service by e.g. applying higher priorities assigned to UAVs 110, or the subscription therein, due to their risk factor as flying objects, which priority information may be included in the environmental conditions applied in the frequency band determination. Moreover as already discussed, the weather information as well as local restrictions may provide tools for selecting optimal radio frequency bands for the communication connection to maintain a controllability of the UAV 110 on a required level. Still further, the task definitions allow a selection of an optimal radio frequency band for the task in question. An example of such a situation may be that the UAV 110, such as a drone, is assigned with a task requiring high throughput capability of data from the communication network, such as a delivery of 8 k video stream, and as a result of the method as described, the UAV 110 is only advertised, or provided, for those frequency bands capable of providing such a service.

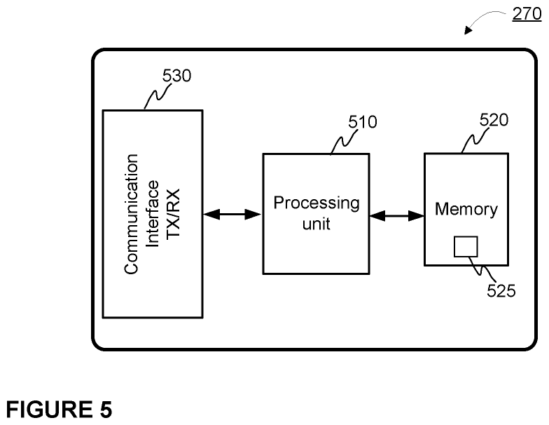

An example of a device suitable for performing a task of the apparatus 270 according to an example embodiment the invention is schematically illustrated in FIG. 5. The apparatus 270 may be configured to implement at least part of the method for managing a communication connection of an unmanned aerial vehicle 110 as described. The execution of the method, or at least some portions of it, may be achieved by arranging at least one processor 510 to execute at least some portion of computer program code 525 stored in at least one memory 520 causing the processor 510, and, thus, the apparatus 270 to implement the method steps as described. In other words, the processor 510 may be arranged to access the memory 520 and to retrieve and to store any information therefrom and thereto. Moreover, the processor 510 may be configured to control a communication through one or more communication interfaces 530 for accessing the other entities being involved in the operation. Hence, the communication interface 530 may be arranged to implement, possibly under control of the processor 510, corresponding communication protocols, such as an IP or any other communication protocol, for communicating with one or more entities. The term communication interface 530 shall be understood in a broad manner comprising necessary hardware and software elements for implementing the communication techniques. Further, the apparatus 270 in question may comprise one or more input/output devices for inputting and outputting information. Such in-put/output devices may e.g. be keyboard, buttons, touch screen, display, loud-speaker, microphone camera and so on. In some implementation of the apparatus 270 at least some of the input/output devices may be external to the apparatus 270 and coupled to it either wirelessly or in a wired manner. For sake of clarity, the processor 510 herein refers to any unit or a plurality of units suitable for processing information and control the operation of the apparatus 270 in general at least in part, among other tasks. The mentioned operations may e.g. be implemented with a microcontroller solution with embedded software. Similarly, the invention is not limited to a certain type of memory 520, but any memory unit or a plurality of memory units suitable for storing the described pieces of information, such as portions of computer program code and/or parameters, may be applied in the context of the present invention. Moreover, at least the mentioned entities may be arranged to be at least communicatively coupled to each other with an internal data connection, such as with a data bus.

In some examples, the apparatus 270 is implemented with a distributed computing environment in which a plurality of computing devices is configured to cooperate to cause an execution of the method according to at least one of the examples as described.

As derivable from above, some aspects of the present invention may relate to a computer program product which, when executed by at least one processor, cause an apparatus 270 to perform at least some portions of the method as described. For example, the computer program product may comprise at least one computer-readable non-transitory medium having the computer program code 525 stored thereon. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for executing the management of the communication connection in the manner as described.

In view of the teaching given herein a functionality of the apparatus 270 configured to perform a method in accordance with the present invention may be inte-grated to an applicable entity residing in a core network of a mobile communication network 130. A non-limiting example of the entity suitable for being configured to perform at least part of the method may be so-called Access and Mobility Management Function, AMF, of 5G mobile communication network. This is because the AMF is responsible for managing an access to the network, but also for providing information of available radio technologies in the network. Still further, the AMF manages handovers (accept/reject) as well as limiting a mobility in general. Hence, the AMF may be configured to perform at least part of the method as well as is suitable for generating the control signal as described in the context of the present invention. According to another implementation, the apparatus 270 may be a dedicated device configured to perform a management of a communication connection in accordance with the present method so as to allow the management of radio frequency bands in the manner as described. For example, it may be arranged to cooperate with the AMF to enable a delivery of the control signal through the AMF. In such an implementation the apparatus may reside in the core network or external to that as long as it is communicatively reachable from the core network, for instance.

The specific examples provided in the description given above should not be construed as limiting the applicability and/or the interpretation of the appended claims. Lists and groups of examples provided in the description given above are not exhaustive unless otherwise explicitly stated.

1. A method for managing a communication connection of an unmanned aerial vehicle, UAV, the communication connection provided by a mobile communication network, the method, performed by an apparatus, comprises:
receiving data indicative of at least one requirement of a communication connection required by the unmanned aerial vehicle,
determining at least one radio frequency band among a radio spectrum of the mobile communication network, the determined at least one radio frequency band complying with the at least one requirement of the communication connection required by the unmanned aerial vehicle,
generating a control signal at least to the unmanned aerial vehicle, the control signal comprising data indicating the determined at least one radio frequency band for applying the determined at least one radio frequency band in the communication between the mobile communication network and the unmanned aerial vehicle.

2. The method of claim 1, wherein the data indicative of the at least one requirement of the communication connection required by the unmanned aerial vehicle is received from a terminal device configured to control the unmanned aerial vehicle at least in part.

3. The method of claim 1, wherein the at least one requirement of the communication connection is defined based on a task definition of the unmanned aerial vehicle, the task definition carried in the received data.

4. The method of claim 3, wherein the task definition comprises data defining at least portion of a flight route of the unmanned aerial vehicle.

5. The method of claim 3, wherein the task definition comprises data indicative of an altitude of a flight of the unmanned aerial vehicle.

6. The method of claim 1, the method further comprising:
receiving data indicative of environmental conditions in relation to the task definition of the unmanned aerial vehicle,
determining, in accordance with the data indicative of the environmental conditions, a number of radio frequency bands as candidate radio frequency bands,
in the method the step of generating a control signal at least to the unmanned aerial vehicle is performed by:
comparing the candidate radio frequency bands to the at least one radio frequency band complying with the at least one requirement of the communication connection required by the unmanned aerial vehicle,
setting, in accordance with a comparison between the candidate radio frequency bands to the at least one radio frequency band complying with the at least one requirement of the communication connection required by the unmanned aerial vehicle, a detection result to indicate the number of radio frequency bands existing both in the candidate radio frequency bands and the at least one radio frequency band complying with the at least one requirement of the communication connection required by the unmanned aerial vehicle, and
including the detection result in the data of the control signal.

7. The method of claim 6, wherein the data indicative of environmental conditions in relation to the task definition of the unmanned aerial vehicle is received by inquiring it from data storage, the inquiry comprising data defining at least the portion of the flight route of the unmanned aerial vehicle defined in the task definition.

8. The method of claim 6, wherein the data indicative of environmental conditions over at least portion of the flight route of the unmanned aerial vehicle is received from at least one of the following: data storage storing weather information; data storage storing local restrictions in the radio spectrum.

9. An apparatus for managing a communication connection of an unmanned aerial vehicle, UAV, the communication connection provided by a mobile communication network, the apparatus configured to:
receive data indicative of at least one requirement of a communication connection required by the unmanned aerial vehicle,
determine at least one radio frequency band among a radio spectrum of the mobile communication network, the determined at least one radio frequency band complying with the at least one requirement of the communication connection required by the unmanned aerial vehicle,
generate a control signal at least to the unmanned aerial vehicle, the control signal comprising data indicating the determined at least one radio frequency band for applying the determined at least one radio frequency band in the communication between the mobile communication network and the unmanned aerial vehicle.

10. The apparatus of claim 9, wherein the apparatus is configured to receive the data indicative of the at least one requirement of the communication connection required by the unmanned aerial vehicle from a terminal device configured to control the unmanned aerial vehicle at least in part.

11. The apparatus of claim 9, wherein the apparatus is configured to define the at least one requirement of the communication connection based on a task definition of the unmanned aerial vehicle, the task definition carried in the received data.

12. The apparatus of claim 11, wherein the apparatus is configured to determine data defining at least portion of a flight route of the unmanned aerial vehicle from the task definition.

13. The apparatus of claim 11, wherein the apparatus is configured to determine data indicative of an altitude of a flight of the unmanned aerial vehicle from the task definition.

14. The apparatus of claim 9, the apparatus further configured to:
receive data indicative of environmental conditions in relation to the task definition of the unmanned aerial vehicle,
determine, in accordance with the data indicative of the environmental conditions, a number of radio frequency bands as candidate radio frequency bands,
the apparatus is configured to perform the step of generating a control signal at least to the unmanned aerial vehicle by:
comparing the candidate radio frequency bands to the at least one radio frequency band complying with the at least one requirement of the communication connection required by the unmanned aerial vehicle,
setting, in accordance with a comparison between the candidate radio frequency bands to the at least one radio frequency band complying with the at least one requirement of the communication connection required by the unmanned aerial vehicle, a detection result to indicate the number of radio frequency bands existing both in the candidate radio frequency bands and the at least one radio frequency band complying with the at least one requirement of the communication connection required by the unmanned aerial vehicle, and
including the detection result in the data of the control signal.

15. The apparatus of claim 14, wherein the apparatus is configured to receive the data indicative of environmental conditions in relation to the task definition of the unmanned aerial vehicle by inquiring it from data storage, the inquiry comprising data defining at least the portion of the flight route of the unmanned aerial vehicle defined in the task definition.

16. The apparatus of claim 14, wherein the apparatus is configured to receive the data indicative of environmental conditions over at least portion of the flight route of the unmanned aerial vehicle from at least one of the following: data storage storing weather information; data storage storing local restrictions in the radio spectrum.

17. A system for managing a communication connection of an unmanned aerial vehicle, UAV, the communication connection provided by a mobile communication network, the system comprising:
at least one unmanned aerial vehicle, UAV; and
an apparatus configured to manage the communication connection of the unmanned aerial vehicle, UAV by:
receiving data indicative of at least one requirement of a communication connection required by the unmanned aerial vehicle,
determining at least one radio frequency band among a radio spectrum of the mobile communication network, the determined at least one radio frequency band complying with the at least one requirement of the communication connection required by the unmanned aerial vehicle,
generating a control signal at least to the unmanned aerial vehicle, the control signal comprising data indicating the determined at least one radio frequency band for applying the determined at least one radio frequency band in the communication between the mobile communication network and the unmanned aerial vehicle.

18. A computer program product comprising at least one non-transitory computer-readable storage medium having computer-executable program code instructions stored therein, the program code instructions being configured, when the computer program product is executed on a computer, to cause the computer at least:
receive data indicative of at least one requirement of a communication connection required by the unmanned aerial vehicle,
determine at least one radio frequency band among a radio spectrum of the mobile communication network, the determined at least one radio frequency band complying with the at least one requirement of the communication connection required by the unmanned aerial vehicle, generate a control signal at least to the unmanned aerial vehicle, the control signal comprising data indicating the determined at least one radio frequency band for applying the determined at least one radio frequency band in the communication between the mobile communication network and the unmanned aerial vehicle.

19. The method of claim 2, wherein the at least one requirement of the communication connection is defined based on a task definition of the unmanned aerial vehicle, the task definition carried in the received data.

20. The method of claim 19, wherein the task definition comprises data defining at least portion of a flight route of the unmanned aerial vehicle.

21. The method of claim 20, wherein the task definition comprises data indicative of an altitude of a flight of the unmanned aerial vehicle.

22. The method of claim 7, wherein the data indicative of environmental conditions over at least portion of the flight route of the unmanned aerial vehicle is received from at least one of the following: data storage storing weather information; data storage storing local restrictions in the radio spectrum.

23. The apparatus of claim 10, wherein the apparatus is configured to define the at least one requirement of the communication connection based on a task definition of the unmanned aerial vehicle, the task definition carried in the received data.

24. The apparatus of claim 23, wherein the apparatus is configured to determine data defining at least portion of a flight route of the unmanned aerial vehicle from the task definition.

25. The apparatus of claim 24, wherein the apparatus is configured to determine data indicative of an altitude of a flight of the unmanned aerial vehicle from the task definition.

26. The apparatus of claim 15, wherein the apparatus is configured to receive the data indicative of environmental conditions over at least portion of the flight route of the unmanned aerial vehicle from at least one of the following: data storage storing weather information; data storage storing local restrictions in the radio spectrum.
